(19) United States
(12) Patent Application Publication
(10) Pub. No.: US 2015/0330134 A1
(43) Pub. Date: Nov. 19, 2015

(54) DEVICE AND METHOD FOR ACTUATING A MOTOR VEHICLE CLOSING DEVICE

(71) Applicant: KIEKERT AKTIENGESELLSCHAFT, Heiligenhaus, North Rhine-Westphalia (DE)

(72) Inventor: Thorsten Bendel, Oberhausen, North Rhine-Westphalia (DE)

(21) Appl. No.: 14/650,602

(22) PCT Filed: Dec. 13, 2013
(86) PCT No.: PCT/DE2013/000779

§ 371 Date: Jun. 9, 2015

(30) Foreign Application Priority Data
Dec. 13, 2012 (DE) 10 2012 024 375.8

(51) Int. Cl. E05F 15/40; E05D 11/08; E05F 15/611

(52) U.S. Cl. CPC E05F 15/40; E05F 15/611; E05D 11/087; E05Y 2900/531

(57) ABSTRACT

The invention relates to a device and a method for actuating a motor vehicle closing device and in particular a motor vehicle side door. The basic structure comprises a motor and optionally a connected transmission and/or a downstream coupling. Also, at least one sensor which is connected to a control unit is provided. According to the invention, the sensor, including the control unit are designed to detect a position (angle α) of the motor vehicle closing device with respect to a motor vehicle body and also at least one additional functional state of the motor vehicle closing device.

### CROSS-REFERENCE TO RELATED APPLICATIONS

This application is the U.S. national stage application of International Patent Application No. PCT/DE2013/000779, filed Dec. 13, 2013, which claims priority of German Application No. 10 2012 024 375.8, filed Dec. 13, 2012, which are both hereby incorporated by reference.

### BACKGROUND

The invention relates to equipment for the activation of a motor vehicle closure device, in particular of a motor vehicle side door, with a motor and if necessary a connected gearbox and/or a downstream coupling; and with at least one sensor connected to a control unit.

Such equipment is for example described in EP 2 236 719 A2 of the applicant. As a whole, this involves being able to pressurise a motor vehicle closure device or motor vehicle side door both mechanically and also manually. In this context, the motor vehicle side door can be set in almost any position. The engageable and disengageable coupling is intended for this purpose, whereby relevant coupling processes can be accomplished with the aid of the motor or the actuator, dependent on the operator's wishes.

In this case, the sensor connected to the control unit reflects the pertaining operator's wish for example to the effect that the motor vehicle side door is retained in the position assumed. An engagement process of the coupling corresponds to this. The motor vehicle closure device or motor vehicle side door may have been previously brought into the desired holding position mechanically or manually. This has proven itself in principle.

Within the scope of DE 196 53 722 A1, an adjustment device is described which is typically used in connection with a sliding door as a motor vehicle closure device. The known adjustment device demonstrates a coupling device connected to an output element and a braking device. The braking device ensures that the coupling device is blocked by traction when the drive element is at rest. This enables gradual adjustment and provides a modular design.

The state of the art cannot be satisfactory in all aspects. Thus, the motor vehicle closure device or motor vehicle side door or also a motor vehicle sliding door manually or mechanically manoeuvred into the desired position is perfectly blocked in the assumed position. This happens regularly by the coupling being closed with the aid of the motor or the actuator. However, within the scope of the known process, a multitude of real operating states cannot be satisfactorily recorded.

Thus, the known devices are for example not able to flexibly take into account certain end stops. However, such end stops during a pivoting movement of a motor vehicle side door are often desired for the case that the pertaining motor vehicle needs to be parked in a garage, car park, etc. In actual fact, with the known equipment there is still the risk that an operator who may be inside the motor vehicle chassis may open the pertaining motor vehicle side door so far after driving into the garage that a collision occurs or could occur with a wall, a pillar or another vehicle. Furthermore, operating states are conceivable in which the motor vehicle side door to be opened, for example, is unintentionally pivoted into a position which was not originally intended by the operator.

Situations are conceivable in which, for example, a motor vehicle driving downhill is parked on a slope or a steep road. If an operator now opens the motor vehicle side door, there is the risk of the motor vehicle side door slipping out of his hand and opening completely. This could not only cause damage to the motor vehicle side door, and potentially obstruct a person on the pavement. But the motor vehicle side door in question may also be removed from the access area of the operator and as a result may no longer be able to be used as an alighting aid or, for example, for storage. This is where the invention is used.

### SUMMARY

The invention is based on the technical problem of further developing such a device for activation of the motor vehicle closure device in such a way that unintentional opening of the door and any damage can be reliably precluded. A relevant procedure should also be specified.

In order to solve this technical issue, a type-appropriate device within the scope of the invention characterised by the fact that the sensor and control unit are set up to record a position of the motor vehicle closure device compared to the chassis and also at least a further functional state of the motor vehicle closure device.

Generally, the device which is the subject of the invention works continuously on both sides. This means the motor vehicle closure device can be continuously held in any position over its entire mechanically specified operational range or continuously manipulated into any position (mechanically, for example). Also, movements on both sides of the motor vehicle closure device are possible in both the opening and closing direction. Within the scope of the invention, not only the position of the motor vehicle closure device compared to the chassis is recorded now with the aid of the sensor, including the control unit. But the sensor in conjunction with the control unit is also set up and trained so that at least one further functional state (in addition to the position) can be recorded and evaluated.

This further functional state may, for example, involve a retention duration of the motor vehicle closure device in the relevant position. i.e. within the scope of the invention in addition to the position of the motor vehicle closure device compared to the chassis the time which the motor vehicle closure device takes to assume the specified position compared to the chassis is recorded. Thus, for example, conclusions can be drawn of necessary end stops.

If a motor vehicle equipped with the device which is the subject of the invention is parked in a garage for the first time for example, it must be expected that an operator slowly approaches a maximum possible opening position of the motor vehicle side door, taking into account local specificities, the first time he alights. As soon as this maximum opening position is attained, it is at least determined for the alighting process. For example, it can occur that the motor or actuator closes the coupling attached to the motor vehicle closure device. Consequently, the motor vehicle closure device or motor vehicle side door is blocked. A significant stoppage duration corresponds to this.

The control unit now concludes from the process and stoppage duration outlined (initial functional state) that the previously assumed position is intermediately saved or should be intermediately saved as an end position so to speak. In this case, not only the stoppage duration of the motor vehicle closure device in the described maximum opening position will regularly be evaluated as the initial functional state, but also the speed of the motor vehicle closure device before attainment of the aforementioned position as the second functional state. Because it must be expected here for the speed to be reduced until attainment of the relevant position. In this regard, naturally the direction of movement of the motor vehicle closure device (‘opening’) as as it were third functional state in conjunction with its speed and the previously assumed position overall indicate that exactly the described functional process is present.

In any case, the control unit can prepare information with evaluation of the position of the motor vehicle closure device and of one or several further functional states which correspond to an end stop for the future. Thus, the invention ensures that the operator cannot open the motor vehicle closure device or motor vehicle side door via the previously ascertained end stop upon return to the vehicle and damage can thus be reliably prevented.

Another scenario is that the operator parks his motor vehicle facing downhill on a steep road. As soon as the control unit with the connected sensor registers in this process that, for example, the speed of the motor vehicle closure device is increasing, this can be interpreted that the motor vehicle closure device is set upwards of a certain threshold value for precautionary reasons. At this threshold value, it can involve a certain opening angle of the motor vehicle closure device or motor vehicle side door and/or an exceeded speed or acceleration. However, once again not only the position of the motor vehicle closure device is evaluated compared to the chassis with the aid of the sensor including the control unit, but at least a further functional state, in the presence of the speed of the motor vehicle closure device or the increase in speed or also its acceleration.

Thus, the invention possesses an ‘intelligent retaining band’. Such retaining bands are still used in great numbers in practice and are equipped with different detent mechanisms for, for example, a motor vehicle side door at pertaining opening angles. In contrast to such rigid positions in determining the motor vehicle side door, the invention not only has recourse to a continuous optional blockade of the motor vehicle closure device or motor vehicle side door which works on both sides. But further functional states are also evaluated, for example a previously assumed position, the speed or acceleration of the motor vehicle closure device for assumption of the position, the direction of movement of the motor vehicle closure device, etc.

Thus, practically all conceivable operating states are outlined and taken into account in the movement of the motor vehicle closure device.

Consequently, any damage is prevented and comfort is increased overall. Because the ‘retaining band’ which is the subject of the invention is ‘intelligent’ in this regard as the ‘previous history’ as it were or also the ‘future’ in which the movement of the motor vehicle closure device is taken into account. These are the crucial advantages.

The sensor used is generally a so-called shaft encoder. The shaft encoder can work optically and/or magnetically. Generally, an optically functioning shaft encoder is used. This is usually designed in such a way that contactless scanning of an angle position follows a pertaining drive shaft, for example. This drive shaft can be connected to the motor vehicle closure device and follows its movement compared to the chassis. A code disc may be connected to the drive shaft which is penetrated with light. This results in a light/dark sample which specifies the angle position of the drive shaft and as a result of its mechanical coupling with the motor vehicle closure device also the angle position of the motor vehicle closure device in question compared to the chassis. The light/dark sample is then converted to an electrical signal and evaluated by the control unit. In this case the shaft encoder works as an absolute encoder.

But it is also possible to arrange the shaft encoder as a resolver or a cog wheel encoder. In this case, a travel of the motor vehicle closure device is reproduced in a smaller unit than actually observed in practice.

The encoder can be connected to the already addressed drive shaft which for its part is coupled with the motor vehicle closure device. In the simplest case, the drive shaft is integrated into a hinge of the motor vehicle closure device or motor vehicle side door. A comparable scenario may also apply to the sensor. i.e. the encoder can for example be integrated into a hinge axle, with the aid of which the motor vehicle closure device or motor vehicle side door is connected supply to the chassis.

The object of the invention is also a procedure for the activation of a motor vehicle closure device as explained in greater details in the claims 7 ff. In this context the control unit can not only evaluate the sensor assigned to the motor vehicle closure device. But furthermore there is also the possibility that the control unit for control of the motor for the motor vehicle closure device also evaluates at least a further sensor. This sensor may be a tilt sensor, a steering angle sensor, a speed sensor of the vehicle, etc.

If, for example, the tilt sensor already addressed is evaluated, a definitive statement can be made as to whether for example the motor vehicle equipped with the device which is the object of the invention is parked on an inclined road or not. i.e. in this case not only the speed of the motor vehicle closure device is evaluated by the operator during manual opening, for example, but also the tilt of the vehicle. If the vehicle is tilting downhill and the speed of the motor vehicle closure device increases at the same time during the opening process, the control unit closes compulsorily as a result, due to the fact that the motor vehicle closure device or motor vehicle side door is opened more or less unintentionally and possibly slips out of the operator's hand.

As a consequence of this, the control unit pressurises the connected motor or actuator in such a way that it closes the coupling on attainment, for example, of a certain position of the motor vehicle closure device. The motor vehicle side door is initially stopped in this specified position as a consequence. Consequently, it cannot slip out of the operator's hand in the case described.

However, with the aid of the device which is the object of the invention practically all conceivable operating states and procedures relating to opening and closure of a motor vehicle closure device can be outlined, whereby the ‘retaining band’ achieved is ‘intelligent’ in this regard as the respective closure or opening process is evaluated and converted into relevant operation commands for the motor.

As already explained at the beginning, the motor is typically an actuator for the coupling. i.e. with the aid of the motor or actuator the coupling can be engaged and disengaged. As usual, the engaged state corresponds to the motor vehicle closure device being set. In contrast to this, the disengaged position of the coupling is due to the motor vehicle closure device being able to be moved freely. This can be achieved manually or mechanically with the aid of an additional drive motor.

However, in principle, the coupling in question is also dispensable, for example where the motor vehicle closure device is a motor vehicle side door. In this case, the motor is not designed as an actuator for the coupling but instead functions as a drive motor. The sliding door discussed is overall an ‘intelligent retaining band’ within the scope of the invention. Because if the pertaining vehicle is for example parked on an incline, a similar scenario as described previously is conceivable. If an operator opens the motor vehicle sliding door in this case, there is the risk of this being directly opened completely as a result of the attacking shear force. This again prevents the invention that evaluates the speed of the motor vehicle closure device with the aid of the obligatory sensor or encoder and is implemented by the control unit in such a way that the motor or drive motor in this case is stopped in a certain position or from a certain acceleration of the motor vehicle closure device or motor vehicle sliding door and blocks this.

The encoder used within the scope of the invention is equipped with the special advantage that both the speed of the motor vehicle closure device and its absolute position can be ascertained practically free from delay and by the control unit. Furthermore, the encoder mostly works optically and is consequently contactless. Consequently, wear or other functional impairments do not need to be feared. This applies all the more as the encoder is regularly accommodated in a capsuled casing. Added to this is that during optical or magnetic functioning of the encoder the output signal is directly evaluated as a digital signal by the control unit and is converted into a position and speed, acceleration, etc. These are the crucial advantages.

Hereinafter, the invention is explained in further detail on the basis of a sketch which only depicts an execution example:

### BRIEF DESCRIPTION OF THE DRAWINGS

FIG. 1 shows the device which is the object of the invention diagrammatically and

FIG. 2 shows the crucial elements of the device according to FIG. 1 in an overview.

### DETAILED DESCRIPTION OF THE DRAWINGS

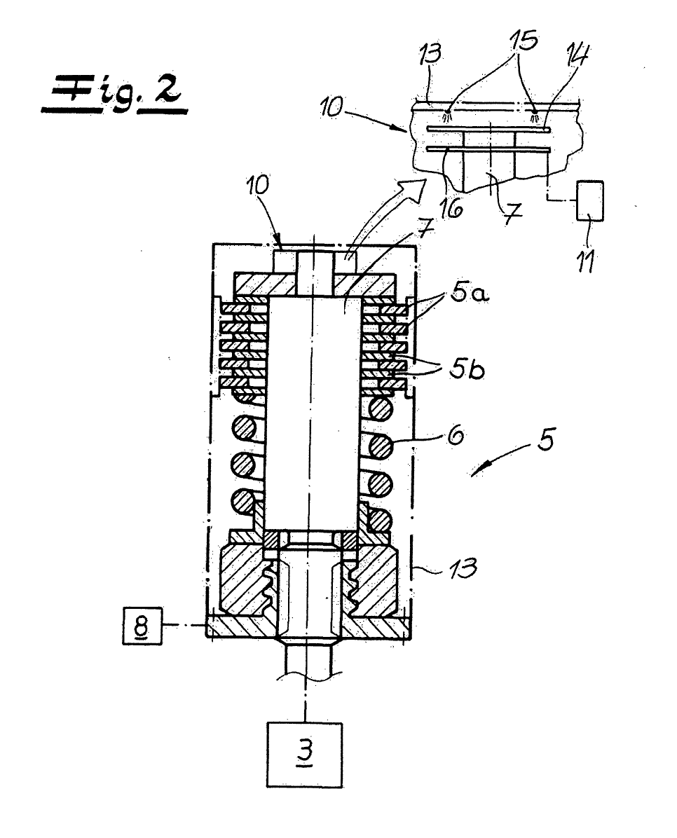

In the figures, a device is depicted to activate a motor vehicle closure device 1. The motor vehicle closure device 1 is a motor vehicle side door 1 within the scope of the execution example and unrestrictedly. The motor vehicle side door 1 can be manually pressurised within the scope of the invention both mechanically and manually. The motor vehicle side door 1 is equipped with a handle 2, 9 and with a motor 3, or electric motor 3 which is recognisable in FIG. 2.

In principle, the electric motor 3 is of course dispensable overall in the case of purely manual activation of the motor vehicle side door 1.

Within the scope of the depiction, the motor or electric motor or actuator 3 is accomplished in the area of a hinge, with the aid of which the motor vehicle closure device or motor vehicle side door 1 is connected supply to a motor vehicle chassis. On the basis of FIG. 2, it is recognised that a coupling 5 is also provided for. The coupling 5 is found within the scope of the execution example between the electric motor or drive motor 3 and the motor vehicle closure device or motor vehicle side door 1.

The coupling 5 is a multiple disc coupling pressurised with the aid of a spring 6. In this context, coupling 5 possesses both stationary friction discs 5b and moving friction discs 5a.

In actual fact, a stationary multiple disc package 5b and a moving multiple disc package 5a are accomplished. The coupling 5 can also be arranged in the area of the hinge axle.

The moving multiple friction discs 5a are connected to the motor vehicle side door 1 and follow each pivot movement of the motor vehicle side door 1 compared to the vehicle chassis 4 with the hinge accomplished in this context. According to how strongly the stationary multiple disc package 5b is applied to the moving multiple disc package 5a, the movement of the motor vehicle closure device or motor vehicle side door 1 can be braked. Adjustable slippage on coupling 5 corresponds to this.

On the basis of FIG. 2, it is further recognisable that a shaft 7 is connected to the stationary multiple disc pair 5b. The shaft 7 can be pressurised by the optional electrical motor or drive motor 3.

With the aid of a motor or actuator 8 the stationary multiple disc package 5b is now more or less switched on to the moving multiple disc package 5a. Thus the slippage of the coupling 5 can be changed. Furthermore, the coupling 5 and consequently the motor vehicle side door 1 can be set with the aid of the actuator 8. To this end, the actuator 8 in the execution example works on the spring 6 which is compressed as a result and increasingly applies the stationary friction discs 5b to the moving friction discs 5a.

A sensor 10 which is connected to shaft 7 in the execution example belongs to the further basic structure. With the aid of the sensor 10 rotary movements or rotational angle movements between shaft 7 and a casing 13 indicated in the dotdashed FIG. 2 are recorded which—as described—follow the pivoting movement of the motor vehicle closure device 1 compared to the motor vehicle chassis 4. In the execution example, the casing 13 incorporates both the coupling 5 and also the sensor or encoder 10 in its interior.

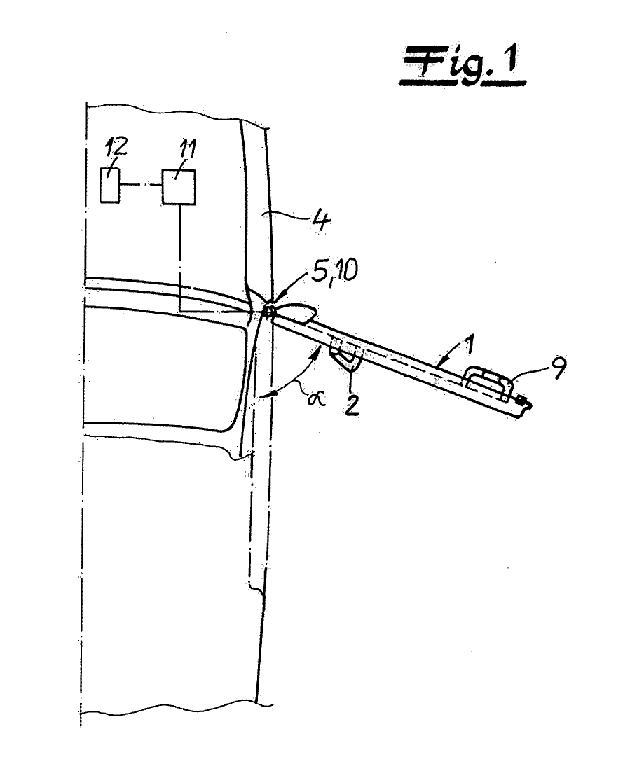

The sensor 10 is—as already stated—an encoder 10 in the execution example, namely an absolute rotary encoder, with the aid of which the respective angle position or motor vehicle closure device or motor vehicle side door 1 compared to the motor vehicle chassis 4, therefore the pertaining opening angle a can be recorded absolutely in accordance with FIG. 1. To this end, the sensor or encoder 10 is constructed in such a way in detail as shown in the enlarged depiction in FIG. 2. Consequently, the angle position of the shaft 7 is scanned wear-free via optical elements compared to the casing 13 indicated by semi colons.

To this end, a code disc 14 is connected to the shaft 7 in the interior of the casing 13 of the sensor or encoder 10. The code disc 14 is penetrated with light from one or several light media 15. The lighting media 15 typically involves one or several LEDs, for example, one or several white light LEDs. An upstream focussing optic or an object lens or a lens provided for on the head side of the LED in each instance are conceivable.

On a static panel 16 in the beam direction behind the code disc 14 as a consequence of this there is a light/dark sample which corresponds to the angle position of the shaft 7 compared to the casing 13 depicted with semi colons. The panel 16 is equipped with a photosensitive material or its own sensor which is read out by the control unit 11. Using the depicted light/dark sample the control unit 11 can directly imply the opening angle α of the motor vehicle closure device 1 compared to the motor vehicle chassis 4.

Generally, the shaft 7 is designed at rest or stationary, whereas the casing 13 is moved together with the motor vehicle side door 1. Thus, the lighting media 15 or LEDs perform a movement which corresponds to that of the motor vehicle side door 1 or implements this. Consequently, the described light/dark sample is depicted on the panel 16 and transmitted and evaluated with the sensor there to the control unit 11 to ascertain the pertaining absolute value for the opening angle α.

As a consequence of this, the sensor or encoder 10 including the control unit 11 is not only able to record a position a of the motor vehicle closure device 1 compared to the motor vehicle chassis 4 which is apparent in the opening angle a. But in addition at least a further functional state of the motor vehicle closure device 1 can be ascertained and evaluated. This functional state may involve the drive speed of the motor vehicle closure device 1 in the execution example. However, alternatively or additionally the movement direction can also be ascertained in the sense of ‘Open’ or ‘Close’.

For example, if the drive speed transmitted manually via for example the internal door handle 2 on the motor vehicle side door 1 in the execution example exceeds a certain threshold or increases, this is interpreted and evaluated by the control unit 11 in such a way that the vehicle chassis 4 is parked on an inclined stretch. In conjunction with this, the motor vehicle side door 1 can be increasingly opened due to the additional downhill downthrust compared to the motor vehicle chassis 4 which results in growing drive speed.

This growing drive speed and associated acceleration of the motor vehicle closure device or the motor vehicle side door 1 can be derived from the signal of the panel 16 or the sensor by the control unit 11. Within the scope of the invention, this leads to the control unit 11 pressurising the actuator 8 in such a way that, from a certain threshold value or upon exceedance of a certain opening angle a, it closes the coupling 5 and consequently blocks the motor vehicle side door 1. This prevents any damage to the motor vehicle side door 1 and possible collisions with people. This can also ensure that the motor vehicle side door 1 still remains in the handling area of the operator who is still inside.

The sensor or encoder 10 cannot only work optically as described, but alternatively or additionally magnetic scanning of the angle or opening angle a is possible. In this case, a disc can be equipped with individual permanent magnets instead of the code disc 14, the scope movement of which is evaluated compared to spools for example instead of the lighting media 15 and associated inductivity change. The functionality is similar to the known ASS sensors in cars.

In FIG. 1 a further sensor 12 is recognised with the aid of which the tilt of the motor vehicle chassis 4 can be recorded. This sensor or tilt sensor 12 can be evaluated by the control unit 11 in addition to the speed of the motor vehicle side door 1. If the control unit 11 receives a signal to the effect that the motor vehicle chassis 4 is tilted, therefore as described was parked on an inclined stretch and if the sensor or encoder 10 registers an increased speed at the time of opening of the motor vehicle side door 1 compared to the motor vehicle chassis 4, this implies the risk of the operator inside the motor vehicle chassis 4 unintentionally letting go of the motor vehicle side door 1 or it slipping away from him.

In order to prevent this, the motor vehicle side door 1 is blocked dependent on the position or its coated opening angle a and in relation to the further functional state (“tilt” or “increase in speed”). Furthermore, in accordance with the invention any end stops are accomplished and implemented continuously, as already described in the introduction.

1. Device for the activation of a motor vehicle closure device, in particular a motor vehicle side door, with a motor and if necessary a connected gearbox and/or downstream coupling, and with at least one sensor connected to a control unit, characterised by the fact that the sensor including the control unit are set up to record a position (angle α) of the motor vehicle closure device compared to a motor vehicle chassis and additionally at least a further functional state of the motor vehicle closure device.

2. Device in accordance with claim 1, characterised by the fact that as a further functional state a holding duration of the motor vehicle closure device in the relevant position (angle α), any end stops, the speed of the motor vehicle closure device is applied before attainment of the position (angle α), a position potentially previously assumed (angle α), the movement direction of the motor vehicle closure device etc.

3. Device according to claim 1, characterised by the fact that the sensor is designed as an encoder.

4. Device according to claim 3, characterised by the fact that the encoder works optically and/or magnetically.

5. Device according to claim 3, characterised by the fact that the encoder is designed as an absolute rotary encoder, resolver or cog wheel encoder.

6. Device according to claim 3, characterised by the fact that the encoder is designed for example in a hinge axis of the motor vehicle closure device.

7. Procedure for the activation of a motor vehicle closure device using a motor and if necessary a connected gearbox and/or a downstream coupling, in accordance with which a sensor connected to a control unit in conjunction with the a control unit records a position (angle α) of the motor vehicle closure device and additionally at least one further functional state of the motor vehicle closure device.

8. Procedure in accordance with claim 7, characterised by the fact that the control unit combines the position (angle α) of the motor vehicle closure device at the same time for example as information regarding the pertaining holding duration, a speed of the motor vehicle closure device, its direction of movement, etc. as a further functional state respectively.

9. Procedure in accordance with claim 7, characterised by the fact that the control unit specifies a drive speed and/or direction of movement for the motor vehicle closure device a holding force, one or several end stops, etc. dependent on the position (angle α) of the motor vehicle closure device and the additionally recorded functional state.

10. Procedure in accordance with claim 7, characterised by the fact that the control unit which controls the motor for the motor vehicle closure device evaluates at least one further sensor, for example a tilt sensor, a steering angle sensor, a speed sensor of the motor vehicle, etc.

11. Procedure in accordance with claim 8, characterised by the fact that the control unit specifies a drive speed and/or direction of movement for the motor vehicle closure device, a holding force, one or several end stops, etc. dependent on the position (angle α) of the motor vehicle closure device and the additionally recorded functional state.

12. Procedure in accordance with claim 11, characterised by the fact that the control unit which controls the motor for the motor vehicle closure device evaluates at least one further sensor, for example a tilt sensor, a steering angle sensor, a speed sensor of the motor vehicle, etc.

13. Device according to claim 2, characterised by the fact that the sensor is designed as an encoder.

14. Device according to claim 13, characterised by the fact that the encoder works optically and/or magnetically.

15. Device according to claim 14, characterised by the fact that the encoder is designed as an absolute rotary encoder, resolver or cog wheel encoder.

16. Device according to claim 15, characterised by the fact that the encoder is designed for example in a hinge axis of the motor vehicle closure device.
